(19) United States
(12) Patent Application Publication
(10) Pub. No.: US 2021/0044881 A1
(43) Pub. Date: Feb. 11, 2021

(54) HOUSINGS AND ASSOCIATED DESIGN FEATURES FOR CEILING ARRAY MICROPHONES

(71) Applicant: Shure Acquisition Holdings, Inc., Niles, IL (US)

(72) Inventors: Gregory William Lantz, Aurora, IL (US); Mark Louis Coster, Wilmette, IL (US); Albert Francis McGovern, JR., Naperville, IL (US); Elizabeth Ahra Cho, Wilmette, IL (US); John Matthew Miller, Grayslake, IL (US); Stuart P. Bauman, Skokie, IL (US)

(21) Appl. No.: 16/825,742

(22) Filed: Mar. 20, 2020

Related U.S. Application Data
(60) Provisional application No. 62/821,771, filed on Mar. 21, 2019.

(51) Int. Cl. H04R 1/08

(52) U.S. Cl. CPC H04R 1/08

(57) ABSTRACT

Housings and associated mechanical and ornamental design features directed to ceiling-mounted electro-acoustical components, such as array microphones, for example, for use in a suspended ceiling, are provided. In an embodiment, a housing for a ceiling array microphone is configured for mounting the microphone within a grid system of a suspended ceiling. The housing comprises a mounting element for mounting the housing within the grid system. The mounting element includes a lipped portion positioned approximate a periphery of the housing and configured to engage the grid when the housing is mounted with the grid system.

### CROSS-REFERENCE

This application claims priority to U.S. Provisional Patent Application No. 62/821,771, filed Mar. 21, 2019, the contents of which is fully incorporated herein by reference.

### TECHNICAL FIELD

This application generally relates to housings and associated design features for electronics packaging. In particular, this application relates to housings and associated mechanical and ornamental design features directed to ceiling-mounted electro-acoustical components, such as array microphones, for use in a suspended ceiling, for example.

### BACKGROUND

Conferencing environments, such as boardrooms, video conferencing settings, and the like, can involve the use of microphones for capturing sound from audio sources, and speakers for disseminating captured sound to an audience in the environment, a telecast, a webcast, etc. The audio sources may include human speakers, for example.

In some environments, the microphones and/or speakers may be placed on a table or lectern near the audio source in order to capture the sound. However, such microphones and speakers may be obtrusive or undesirable, due to their size and/or the aesthetics of the environment in which the microphones are being used. In addition, microphones placed on a table can detect undesirable noise, such as pen tapping or paper shuffling. Microphones placed on a table may also be covered or obstructed, such as by paper, cloth, or napkins, so that the sound is not properly or optimally captured.

In other environments, the microphones may include shotgun microphones that are primarily sensitive to sounds in one direction. The shotgun microphones can be located farther away from an audio source and can be directed to detect the sound from a particular audio source by pointing the microphone at the area occupied by the audio source. However, it can be difficult and tedious to determine the direction to point a shotgun microphone to optimally detect the sound coming from its audio source. Trial and error may be needed to adjust the position of the shotgun microphone for optimal detection of sound from an audio source. As such, the sound from the audio source may not be ideally detected unless and until the position of the microphone is properly adjusted. And even then, audio detection may be less than optimal if the audio source moves in and out of a pickup range of the microphone (e.g., if the human speaker shifts in his/her seat while speaking).

In some environments, microphones and/or speakers may be mounted to a ceiling or wall of the conference room to free up table space and provide human speakers with the freedom to move around the room, thereby resolving at least some of the above concerns with tabletop and shotgun microphones. In some ceiling-mount microphone or speaker designs, it may be desirable to directly secure the microphone or speaker to the ceiling or hang it from the ceiling. In other designs, it may be desirable to utilize an existing suspended ceiling grid to mount the microphone or speaker. Further, while ceiling microphones may not pick up tabletop noises given their distance from the table, such microphones have their own audio pickup challenges due to a closer proximity to speakers and HVAC systems, a further distance from audio sources, and an increased sensitivity to air motion or white noise. And in situations where ceiling microphones are mounted within a suspended ceiling grid, there are other factors at play, such as, for example, various building codes or certification requirements, and microphone performance/quality variables related to various mounting configurations and enclosure designs.

Accordingly, there is an opportunity for designs that, among other things, allow flexibility in mounting and performance considerations depending on the specific installation or environment.

### SUMMARY

In an embodiment, a housing for a ceiling array microphone is configured for mounting the microphone within a grid system of a suspended ceiling. The housing comprises a mounting element for mounting the housing within the grid system. The mounting element includes a lipped portion positioned approximate a periphery of the housing and configured to engage the grid when the housing is mounted with the grid system.

In an embodiment, the mounting element comprises a frame around the periphery of the housing. In some embodiments, the frame has a curved or curvilinear profile. In some embodiments, the frame may comprise two or more components.

In an embodiment, the mounting element is configured to be separate and attachable to the housing.

In embodiments, the lipped portion is configured to rest on a flat surface of the grid member.

In embodiments, the mounting element is configured to cause a front surface of the ceiling array microphone to be positioned below the suspended ceiling.

In some embodiments, the housing further comprises a front panel, the mounting element being further configured for attachment to the front panel.

In some embodiments, the housing further comprises a back portion forming a back surface of the ceiling array microphone, the mounting element being further configured for attachment to the back portion.

In some embodiments, the mounting element further comprises an end portion positioned opposite the lipped portion, and a protrusion portion configured to extend between the lipped portion and the end portion, the protrusion portion having a length configured to cause a front surface of the ceiling array microphone to be positioned below the suspended ceiling.

In some embodiments, the housing further comprises a frame element defining a peripheral border of the ceiling array microphone, the mounting element being further configured for attachment to the frame element.

In some embodiments, the housing further comprises a back portion disposed below the lipped portion, the mounting element attaching to the frame element adjacent the back portion.

In an embodiment, the housing further comprises a back portion forming a back surface of the ceiling array microphone, and the mounting element is a bracket comprising the lipped portion and coupled to the back portion of the housing. In some embodiments, the bracket is configured to cause the back surface to be positioned below the suspended ceiling.

These and other embodiments, and various permutations and aspects, will become apparent and be more fully understood from the following detailed description and accompanying drawings, which set forth illustrative embodiments that are indicative of the various ways in which the principles of the invention(s) may be employed.

### BRIEF DESCRIPTION OF THE DRAWINGS

FIG. 1 is a top perspective view of an embodiment of a ceiling array microphone in accordance with one or more principles of the invention(s) described herein. For orientation reference, “top” refers to a viewing direction of a portion of the microphone that would face the interior space of a suspended ceiling, i.e., drop space.

FIG. 2 is a bottom perspective view of an embodiment of a ceiling array microphone in accordance with one or more principles of the invention(s) described herein. For orientation reference, “bottom” refers to a viewing direction of a portion of the microphone that would face the interior space of a room having the suspended ceiling, i.e., room space.

FIG. 3 is a top perspective view of an embodiment of a ceiling array microphone installed within a ceiling grid of a suspended ceiling, in accordance with one or more principles of the invention(s) described herein.

FIG. 4 is a top perspective view of an embodiment of a ceiling array microphone installed within a ceiling grid of a suspended ceiling, in accordance with one or more principles of the invention(s) described herein.

FIG. 5 is a partial cross-sectional side view of an embodiment of a ceiling array microphone in accordance with one or more principles of the invention(s) described herein.

FIG. 6 is a partial cross-sectional side view of an embodiment of a ceiling array microphone in accordance with one or more principles of the invention(s) described herein.

FIG. 7 is a side view of an embodiment of a ceiling array microphone installed within a ceiling grid of a suspended ceiling, in accordance with one or more principles of the invention(s) described herein.

FIG. 8 is a partial cross-sectional side view of an embodiment of a ceiling array microphone installed within a ceiling grid of a suspended ceiling, in accordance with one or more principles of the invention(s) described herein.

FIG. 9 is a partial cross-sectional perspective view of an embodiment of a ceiling array microphone installed within a ceiling grid of a suspended ceiling, in accordance with one or more principles of the invention(s) described herein.

FIG. 10 is a partial cross-sectional side view of an embodiment of a ceiling array microphone in accordance with one or more principles of the invention(s) described herein.

FIG. 11 is a bottom perspective view of an embodiment of a ceiling array microphone in accordance with one or more principles of the invention(s) described herein.

FIG. 12 is a top perspective view of an embodiment of a ceiling array microphone in accordance with one or more principles of the invention(s) described herein.

FIG. 13 is a partial cross-sectional side view of a frame of a ceiling array microphone housing in accordance with one or more principles of the invention(s) described herein, illustrating a curvilinear profile of the frame.

FIG. 14 is a partial perspective view of a frame of a ceiling array microphone housing in accordance with one or more principles of the invention(s) described herein, illustrating a curvilinear profile of the frame.

FIG. 15 is a top perspective view of an embodiment of a ceiling array microphone installed within a ceiling grid of a suspended ceiling, in accordance with one or more principles of the invention(s) described herein.

FIG. 16 is a bottom perspective view of an embodiment of a ceiling array microphone installed within a ceiling grid of a suspended ceiling, in accordance with one or more principles of the invention(s) described herein.

FIG. 17 is a side view of an embodiment of a ceiling array microphone installed within a ceiling grid of a suspended ceiling, in accordance with one or more principles of the invention(s) described herein.

FIG. 18 is a partial cross-sectional side view of an embodiment of a ceiling array microphone installed within a ceiling grid of a suspended ceiling, in accordance with one or more principles of the invention(s) described herein.

FIG. 19 is a partial cross-sectional side view of an embodiment of a ceiling array microphone in accordance with one or more principles of the invention(s) described herein, illustrating a curvilinear profile of the frame.

FIG. 20 is a bottom perspective view of an embodiment of a ceiling array microphone in accordance with one or more principles of the invention(s) described herein.

FIG. 21 is a top perspective view of an embodiment of a ceiling array microphone in accordance with one or more principles of the invention(s) described herein.

### DETAILED DESCRIPTION

The description that follows describes, illustrates and exemplifies one or more particular embodiments of the invention(s) in accordance with its principles. This description is not provided to limit the invention(s) to the embodiments described herein, but rather to explain and teach the principles of the invention(s) in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention(s) as taught herein and understood to one of ordinary skill in the art.

The disclosures herein are directed to housings, mechanical packaging and mounting, and design concepts for electro-acoustical devices, such as microphones, microphone arrays, beamforming microphone arrays, speakers, speaker arrays, and the like. Many of the embodiments described and illustrated herein are directed to ceiling array microphones, but it should be understood that some of the concepts and other principles can be applied with respect to other devices and electronics packaging, and other form factors, and as such, this disclosure should not be limited thereby. For ease of reference and illustration, the following descriptions refer to ceiling microphone arrays, with the understanding that the concepts and principles may apply to other devices as well.

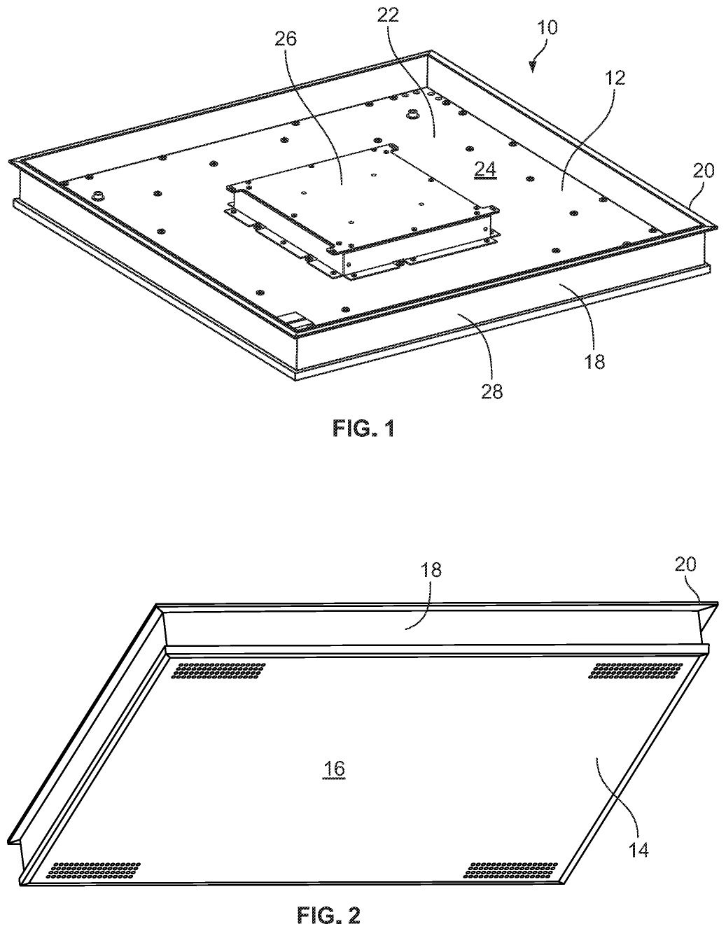

Referring to the drawings, FIGS. 1 and 2 are top and bottom perspective views, respectively, of an embodiment of a ceiling array microphone 10 in accordance with one or more principles of the invention(s) described herein. As shown, the ceiling array microphone 10 comprises a housing 12 and serves as electronics packaging for associated electrical, acoustical and electro-acoustic components of the microphone array. Such components may include, for example, one or more PCBs, electronics mounting apparatus or chassis, microphones (such as, for example, MEMS microphones), controllers, mixers, connector ports, etc. The microphone array may include one or more processors, and may include functions such channel selection, beamforming, mixing, per channel or post-mix acoustic echo cancellation (AEC), or other functions associated with microphone products, such as beamforming microphone arrays. In some embodiments, the ceiling array microphone may also incorporate one or more speakers.

As used herein, and for ease of reference, “top” or “back” refers to the portion of the ceiling array microphone that would face the interior space of a suspended ceiling, i.e., drop space. Conversely, “bottom” or “front” refers to the portion of the ceiling array microphone that would face the interior space of a room having the suspended ceiling, i.e., room space. As shown in FIG. 2, the housing 12 further comprises a front panel 14 having a front surface 16 which allows acoustic energy to pass therethough to the microphones housed within the housing. In some embodiments, the panel 14 may have perorations or other apertures, such as a metal or plastic screen or cover, or a cloth or foam material of a porous or semi-porous nature. A mounting element 18 in the form of a frame is disposed around the periphery of the housing. The mounting element 18 includes a lipped portion 20 for use when the ceiling array microphone 10 is mounted within a grid system of a suspended ceiling, as will be further described herein. Referring to FIG. 1, the housing 12 further comprises a back panel 22 having a back surface 24. In some embodiments, a back housing 26 is disposed on the back surface 24 which provides further packaging space for components, such as one or more processors, connection ports, etc.

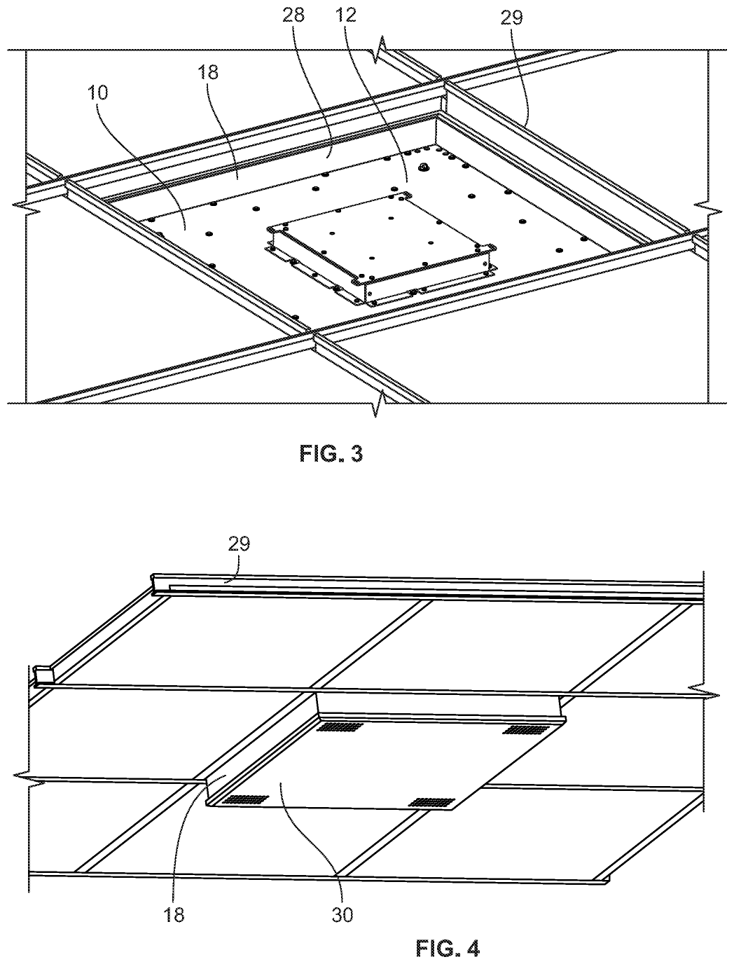

As is apparent from FIG. 1, the mounting element 18 has a protrusion portion 28, which, as illustrated in FIG. 3, allows the other portions of the housing 12 of the ceiling array microphone 10 to extend away from a surrounding suspended ceiling and protrude into the space of an interior room when the ceiling array microphone is installed within a grid system via the lip portion 20 of the mounting element 18. Depending on room characteristics, installation, and other variables and requirements, this feature may provide better performance of the ceiling array microphone. Additionally, this feature may provide benefits for certain building codes or certifications. For example, certain codes or certifications, such as fire codes or UL certifications, may require certain design parameters, such as, for example, that any electronics being mounted in the suspended ceiling be mounted such that no portion is located within the plenum or drop space of the ceiling. Such a configuration also eliminates obstructions in the plenum or drop space that could otherwise interfere with plumbing, HVAC ducting, electrical conduit, or other components within the plenum or drop space. Additionally, as apparent from FIG. 3, the protrusion design of the housing allows for a ceiling tile to still be installed in a grid system 29 where the ceiling array microphone 10 is installed, which may be beneficial for meeting certain fire codes or other requirements by eliminating the need to place insulation or fiber blankets over the back of the ceiling array microphone.

As shown in FIG. 4, the ceiling array microphone 10 protrudes downward into the room by virtue of the mounting element 18. The mounting element 18 can be configured in various shapes, sizes and dimensions, as will be described herein. The amount of protrusion can be configured accordingly. In an embodiment, the mounting element 18 includes a bezel element 30, which, as will be described, among other things, provides for attachment of the front panel 14. In other embodiments, one or more of the housing components may be of a unitary design. For example, the mounting element 18 may be integrated with the front panel 14 or the back panel 22 of the ceiling array microphone. Additionally, it should be noted that while the front panel 14 and the back panel 22 are shown as relatively flat panel-like structures, these components may also take form factors such as a box-like shape or other geometric shapes, depending on the form factor of the housing of the ceiling array microphone. In the embodiment shown, the protrusion portion 28 is of a solid contiguous nature around the periphery of the housing 14, such that when the ceiling array microphone is installed, there is no gap or sight line to the drop space when observed from within the room. This provides an aesthetically pleasing installation.

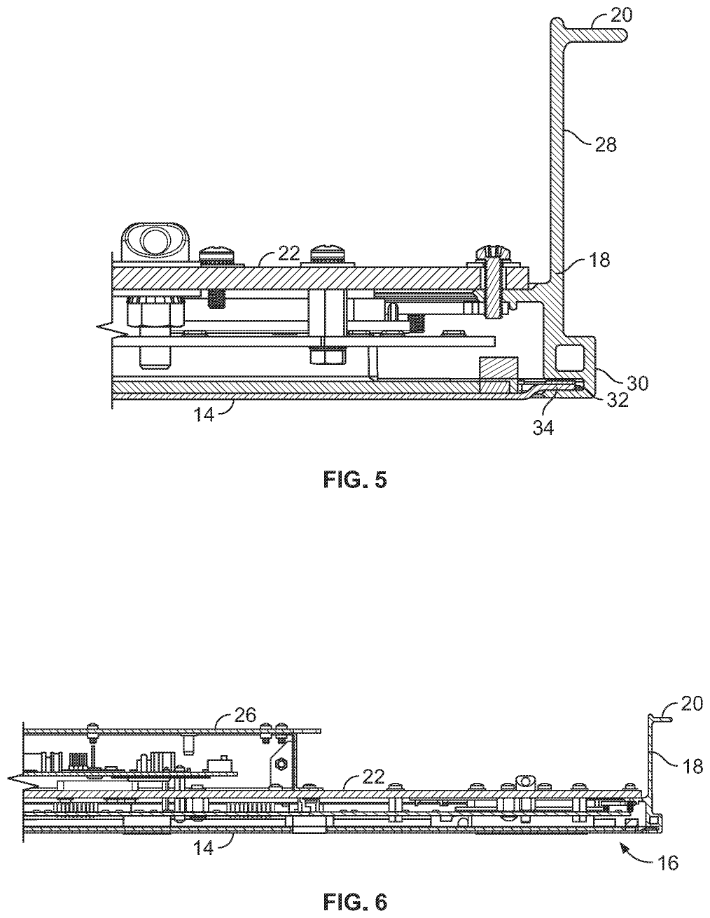

Referring to FIGS. 5 and 6, in some embodiments the mounting element 18 is configured to be mechanically fastened to the back panel 22. As shown in FIG. 5, the mounting element 18 includes a slot 32 in the bezel element 30, the slot 32 being configured to engage an edge portion 32 of the front panel 14 when assembled. A resilient member 34 may be provided within the slot 32 as shown in FIG. 5, which among other things, counteracts any issues associated with assembly tolerance stack. The resilient member 34 may be made out of any resilient material, such as foam, rubber or other elastomeric material.

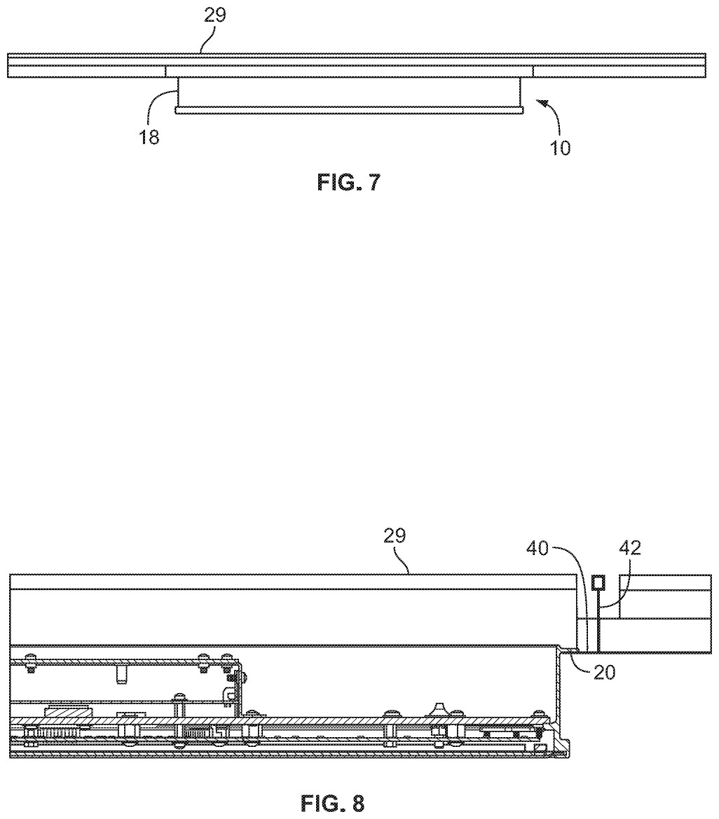

FIGS. 7 and 8 show the ceiling array microphone 10 installed within the grid system 29 of a suspended ceiling system. As shown in FIG. 7, by virtue of the mounting element 18, the ceiling array microphone protrudes into the room within which the suspended ceiling is installed. The dimensions of the mounting element 18 can be configured to determine the amount of protrusion into the room. This may be advantageous depending on the application and varied environment characteristics. In some embodiments, the mounting element 18 is removable and exchangeable with other mounting elements having various dimensions. This would allow an integrator or installer to customize the installation.

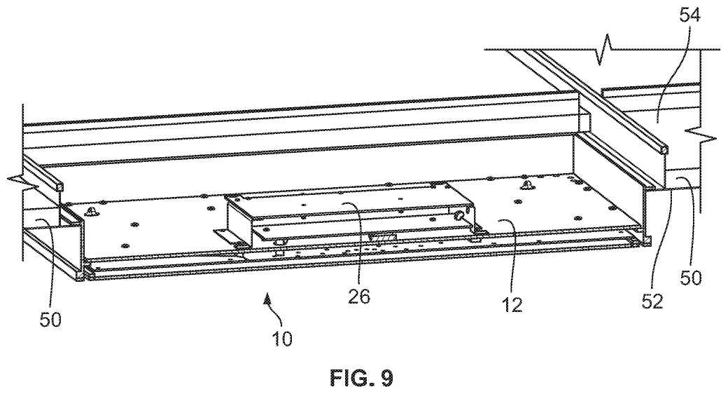

As shown in FIG. 8, the lipped portion 20 of the mounting element 18 is configured to engage a panel surface 40 of a grid member 42 of the grid system 29. In the embodiment illustrated, the lipped portion 20 rests on the panel surface 40. In some embodiments, the lipped portion 20 of the mounting element 18 is contiguous around the periphery of the ceiling array microphone, thereby being supported by the grid system generally contiguously around the periphery. In other embodiments, the lipped portion 20 may be configured in intervallic portions around the periphery of the ceiling array microphone. FIG. 9 shows a cross-sectional view of the ceiling array microphone 10 installed within the grid system 29. FIG. 9 illustrates the general dimensional and spatial relationships between the ceiling array microphone 10 and the surrounding ceiling tiles 50, such as the lowered position of the portions of the housing 12 containing the electronics and microphones of the ceiling array microphone 10. As illustrated, the back housing 26 is below the plane formed by an interior room surface 52 of the surrounding ceiling tiles. In some embodiments, the back housing 26 would be at or below an interior surface 54 of the surrounding ceiling tiles.

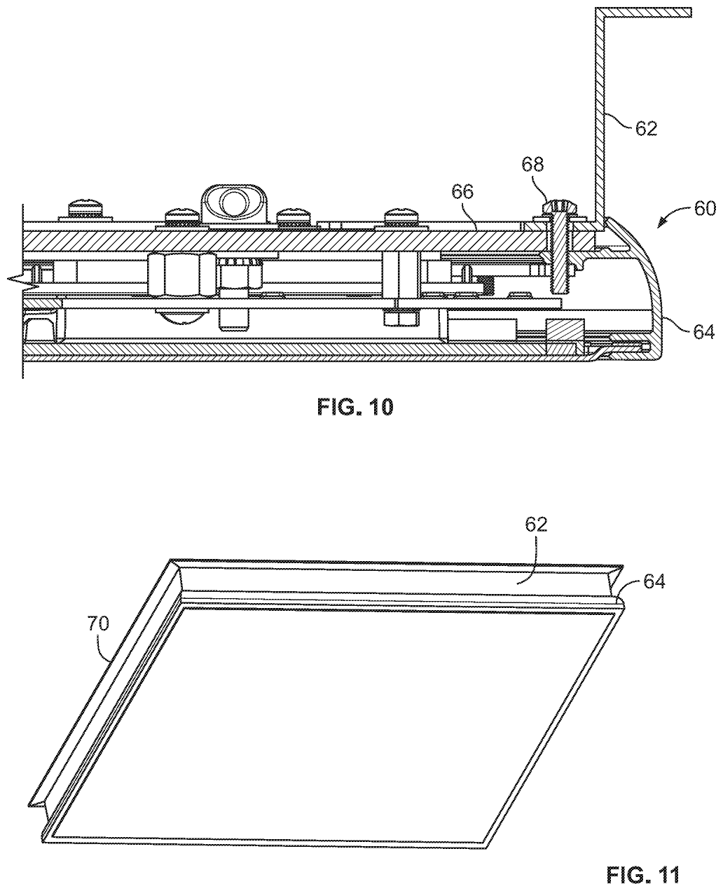

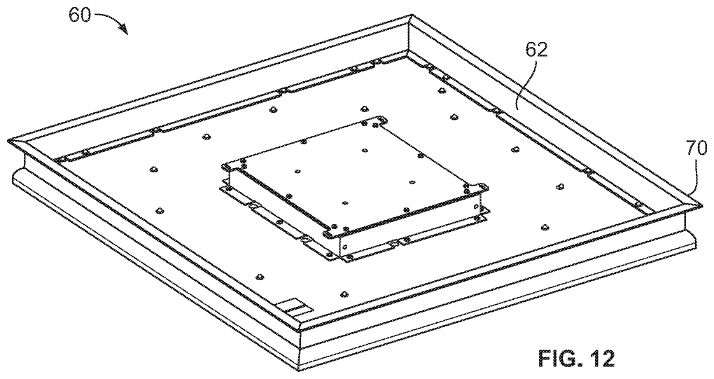

FIGS. 10 and 11 illustrate another embodiment of a ceiling array microphone 60 where a mounting element 62 is separate from a frame element 64, where the frame element 64 defines a peripheral border with a curved, linear or curvilinear profile. This configuration provides flexibility in providing numerous ornamental shapes and designs. The overall visual appearance of the ceiling array microphone 60 having the frame element 64 can be seen in FIG. 11. In other embodiments, the mounting element 62 may be unitary with the frame element 64. As illustrated in FIG. 10, the mounting element 62 is attachable to a back portion 66 of the ceiling array microphone. In the illustrated embodiment, the mounting element 62 is attachable to the back portion 66 of the ceiling array microphone by mechanical fastening via one or more mechanical fasteners 68. Other fastening methods, such as adhesive, welding, or friction fit, are contemplated as well. As shown in FIG. 12, the ceiling array microphone 60 and mounting element 62 are configured such that the portions of the ceiling array microphone 60 containing the electronics and microphones are positioned below a lipped portion 70 of the mounting element 62, such that when installed in a ceiling grid system, those portions would be positioned below a plane formed by an interior room surface of the surrounding ceiling tiles. In some embodiments, the ceiling array microphone can be configured such that when mounted, the portions of the ceiling array microphone 60 containing the electronics and microphones are at or below an inner surface of the surrounding ceiling tiles.

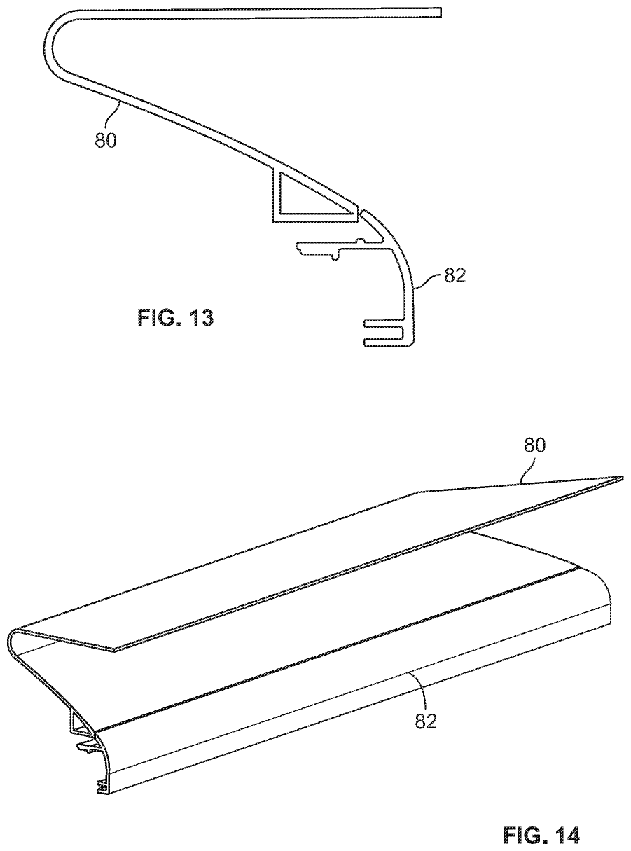

FIGS. 13 and 14 show a profile and perspective view of another embodiment of a mounting element 80, which has a curvilinear shape. As illustrated, the mounting element 80 and a frame element 82 together create a curvilinear form factor. It should be understood that numerous other linear, curved, curvilinear and other geometries are contemplated to provide numerous possible ornamental shapes and designs when incorporated into a ceiling array microphone as contemplated herein. It should also be understood that the mounting element 80 and frame element 82 may be of a unitary design.

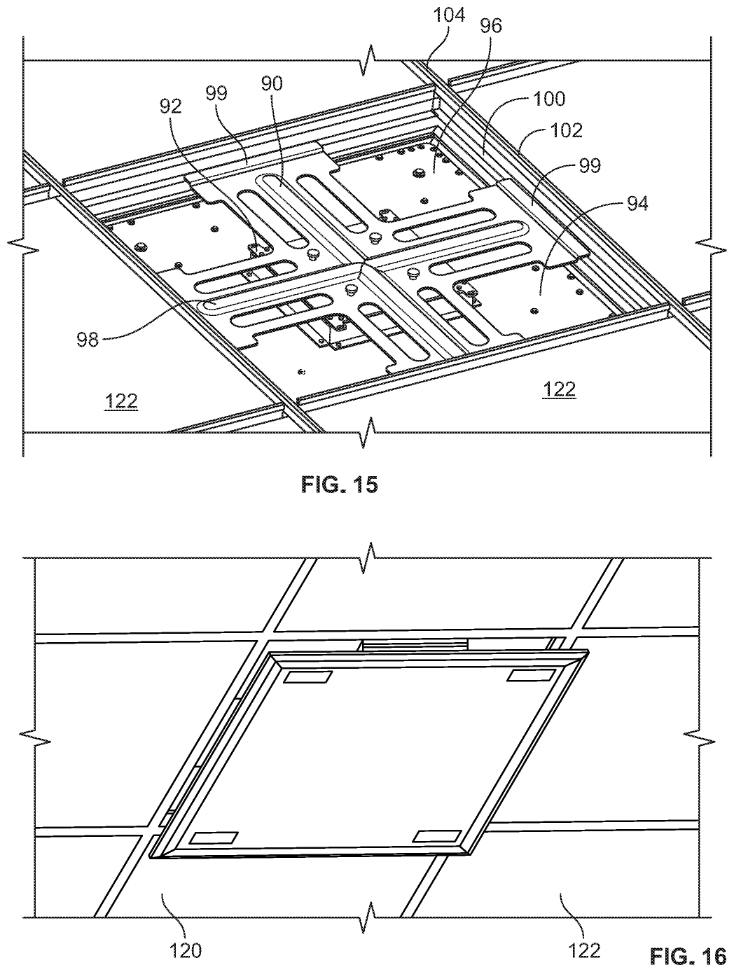

FIGS. 15 and 16 show yet another embodiment where a bracket 90 is attached to a back portion 92 of a housing 94 of a ceiling array microphone 96. In this embodiment, the bracket 90 includes a plurality of extensions 98, each having a lipped portion 99 configured to engage a panel surface 100 of a grid member 102 of a grid system 104. Again, as with other embodiments, the bracket 90 positions the ceiling array microphone such that the portions of the housing 94 containing the electronics and microphones of the ceiling array microphone 96 are positioned below the plane formed by an interior room surface 120 of surrounding ceiling tiles 122.

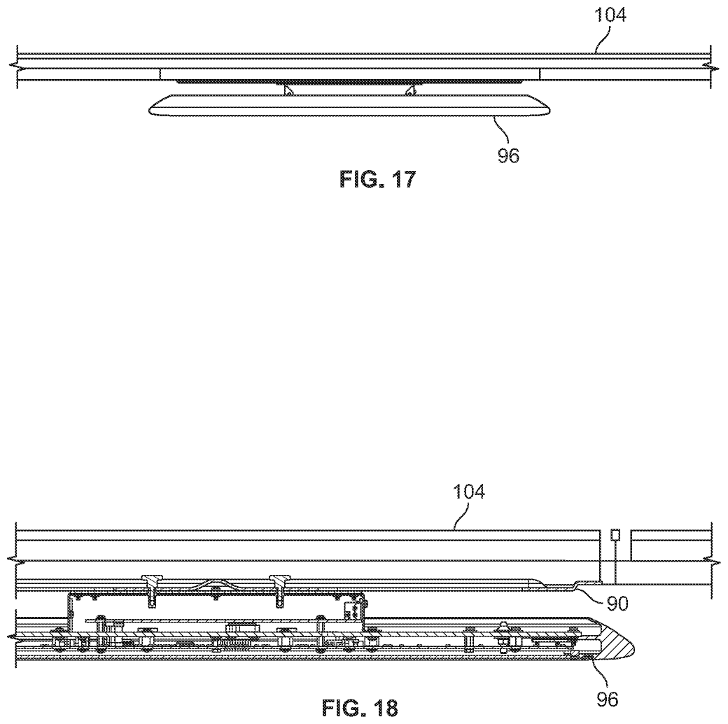

FIGS. 17 and 18 further illustrate the mounting of the ceiling array microphone 96 within the grid system 104. The bracket 90 can be mechanically fastened to the back portion 92 of the housing 94 via fasteners or adhesive, and in some embodiments, the bracket 90 can be integrally formed with a portion of the housing 94. Referring to FIGS. 15 and 16, it can be seen that a gap exists between the housing 94 and surrounding ceiling tiles 122, which at some viewing angles allows a person within the room to see into the drop space of the suspended ceiling. Accordingly, in cases where this is not desirable, some embodiments may deploy a solid bracket such that no opening into the drop space would exist. In other embodiments, a cover or ceiling tile may be placed over the bracket 90 to accomplish a similar result.

It is also contemplated that the bracket 90 can be used to attach one end of an extension pole (not shown) thereto in lieu of attaching directly to the ceiling array microphone. An opposing end of the extension pole can be attached to the ceiling array microphone. In such an embodiment, the extension pole would provide further protrusion of the ceiling array microphone into the interior room space. The extension pole can be an off-the-shelf type of pole typically used for ceiling projectors or the like, or it can be specifically designed for the applications contemplated herein. Although typically cylindrical in shape, the extension pole can take any number of forms, such as a rectangular or bar shape, I-beam shape, or can even be a cable or wire, for example. In some embodiments, the extension pole and the bracket can be configured with a cam-lock type attachment system, where an end of the extension pole has either one or more slots or protrusions that engage corresponding one or more slots or protrusions in the bracket, such that when the end of the pole is mated to the corresponding slots or protrusions, it can be twisted into an engaged position. It is also contemplated that such a mounting configuration could also be incorporated directly into the housing of the ceiling array microphone for direct mounting to the bracket, such that the ceiling array microphone can be cam-locked or twist-locked directly to the bracket. It is also contemplated that both the pole/bracket and the pole/microphone attachments be a cam-style or twist-lock attachment configuration.

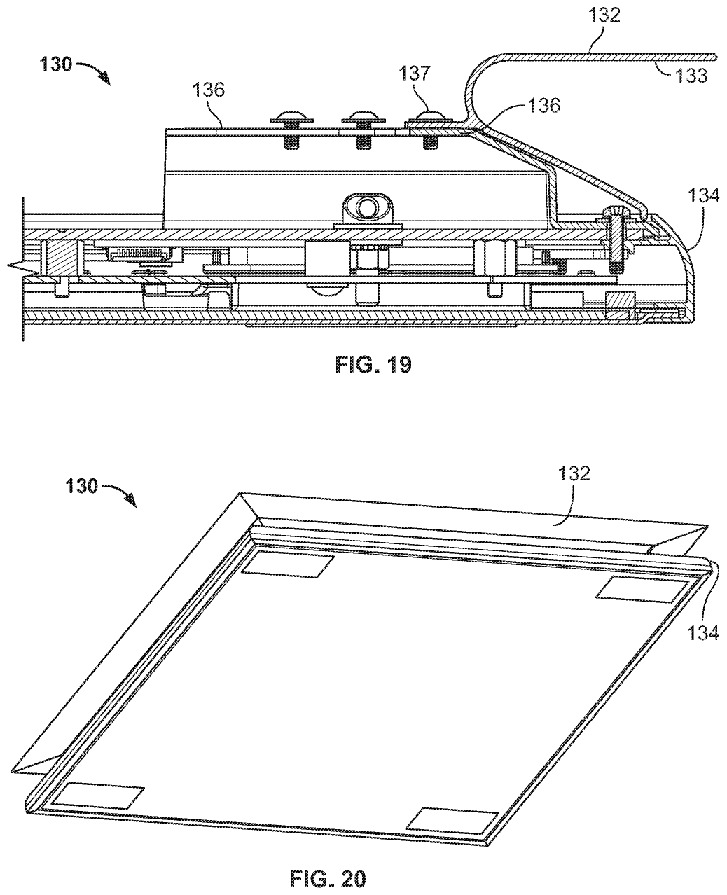

FIG. 19 shows yet another embodiment in partial cross-section, which illustrates yet another curvilinear profile of a ceiling array microphone 130. As shown, a mounting element 132 is separate from a frame element 134, where the frame element 134 defines a peripheral border with a curved, linear or curvilinear profile. The mounting element 132 provides further profile context and can be curved, linear or curvilinear in profile. This configuration provides flexibility in providing numerous ornamental shapes and designs, while still functioning to mount the ceiling array microphone within a ceiling grid system of a suspended ceiling. The mounting element 132 is configured with a flange or lipped portion 133 that engages a surface of the ceiling grid for installation within a suspended ceiling.

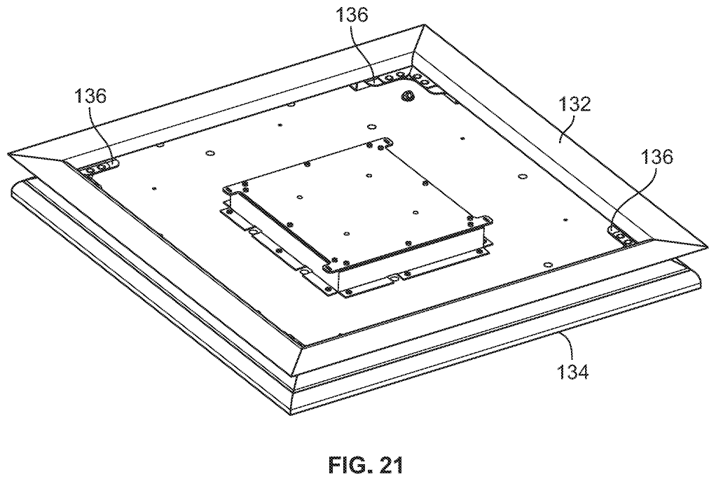

The overall visual appearance of the ceiling array microphone 130 having the mounting element 132 and the frame element 134 can be seen in FIGS. 20 and 21. In other embodiments, the mounting element 132 may be unitary with the frame element 134. As illustrated in FIG. 19, the mounting element 132 is attachable to a support member 136 of the ceiling array microphone. This attachment scheme allows the curvature of the mounting element 132 to be more pronounced inwardly toward a center of the ceiling array microphone 130 while still providing adequate rigidity and support in a mounted configuration. The attachment can be made by mechanical fasteners, such as screws 137, or adhesive, welding, friction fit, or any other methods of attachment known in the art. As shown in FIG. 21, support members 136 are disposed at each general corner of the ceiling array microphone 130, but it should be understood that other support structures are contemplated as well, such as a contiguous or intervallic frame member disposed about the general periphery of the ceiling array microphone, or utilization of a back surface of a housing of the ceiling array microphone where the mounting element 132 is directly attached or formed integrally therewith.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A ceiling array microphone comprising a housing configured for mounting the ceiling array microphone within a grid system of a suspended ceiling, the housing comprising a mounting element for mounting the ceiling array microphone within the grid system, the mounting element comprising a lipped portion positioned approximate a periphery of the housing and configured to engage a grid member when the housing is mounted with the grid system, wherein the mounting element is configured to cause a front surface of the ceiling array microphone to be positioned below the suspended ceiling.

2. The ceiling array microphone of claim 1, wherein the lipped portion is configured to rest on a flat surface of the grid member.

3. (canceled)

4. The ceiling array microphone of claim 1, wherein the housing further comprises a front panel, the mounting element being further configured for attachment to the front panel.

5. The ceiling array microphone of claim 1, wherein the housing further comprises a back portion forming a back surface of the ceiling array microphone, the mounting element being further configured for attachment to the back portion.

6. The ceiling array microphone of claim 1, wherein the mounting element further comprises an end portion positioned opposite the lipped portion, and a protrusion portion configured to extend between the lipped portion and the end portion, the protrusion portion having a length configured to cause the front surface of the ceiling array microphone to be positioned below the suspended ceiling.

7. The ceiling array microphone of claim 1, wherein the housing further comprises a frame element defining a peripheral border of the ceiling array microphone, the mounting element being further configured for attachment to the frame element.

8. The ceiling array microphone of claim 7, wherein the housing further comprises a back portion disposed below the lipped portion, the mounting element attaching to the frame element adjacent the back portion.

9. The ceiling array microphone of claim 1, wherein the housing further comprises a back portion forming a back surface of the ceiling array microphone, and the mounting element is a bracket comprising the lipped portion and coupled to the back portion of the housing.

10. The ceiling array microphone of claim 9, wherein the bracket is configured to cause the back surface to be positioned below the suspended ceiling.

11. The ceiling array microphone of claim 1, further comprising a back electronics housing disposed on a back surface of the housing, the mounting element being configured to position the back surface and at least a portion of the back electronics housing below the suspended ceiling.

12. The ceiling array microphone of claim 1, wherein the mounting element is configured to cause a back portion of the ceiling array microphone to be positioned below the suspending ceiling.
